(19) United States
(12) Patent Application Publication
(10) Pub. No.: US 2015/0073700 A1
(43) Pub. Date: Mar. 12, 2015

(54) DATA PROCESSING SYSTEM AND METHOD FOR GENERATING GUIDING INFORMATION

(71) Applicant: PopWorld Inc., New Taipei City (TW)

(72) Inventor: SHENG-HUNG HUANG, New Taipei City (TW)

(21) Appl. No.: 14/485,149

(22) Filed: Sep. 12, 2014

(30) Foreign Application Priority Data
Sep. 12, 2013 (TW) 102132903
Apr. 2, 2014 (TW) 103112222

(51) Int. Cl. G01C 21/36

(52) U.S. Cl. CPC G01C 21/3679
USPC 701/438

(57) ABSTRACT

The invention discloses a data processing system and method for generating a guiding information. The data processing system according to a preferred embodiment of the invention includes an importing module, an editing module and a generating module. A producer imports a plurality of parameters relative to a plurality of positions through the importing module. The producer edits a plurality of introduction information of the plurality of positions through the editing module. The generating module generates the guiding information in accordance with the plurality of parameters relative to the plurality of positions and the plurality of introduction information of the plurality of positions.

### CROSS-REFERENCE TO RELATED APPLICATION

This utility application claims priority to Taiwan Application Serial Number 102132903, filed Sep. 12, 2013, and Taiwan Application Serial Number 103112222, filed Apr. 02, 2014 which are incorporated herein by reference.

### BACKGROUND OF THE INVENTION

1. Field of the Invention

The invention relates to a data processing system and method for generating a guiding information available for activities associated with predetermined routes or tours.

2. Description of the Prior Art

So far, multimedia have been developed to include texts, pictures, animations, sounds, videos, games, and other forms of media. With the development of information and communication technologies, diverse forms of multimedia have also been transmitted to mobile communication apparatus.

Nowadays, most of the activities of people relate to predetermined routes or limit within predetermined region, thus develop into sports, leisure, learning, for example, orienteering, biking, motorcycling around the island, or walking at the playground, exhibition, campuses, parks, etc. However, current information technologies relative route have only navigating technology. Currently, there is no technology of multimedia triggered by assigned position on a route been presented.

In addition, nowadays, most of multimedia is customized and produced with time consuming of professionals. General non-professionals making it difficult to participate in production of multimedia.

Most of countries pay attention to tourism market. Most of forms of tourism are still largely in force by the tour guide. With the popularity of sharing travel information through networks, backpacking tourism accounted ratio has increased year by year. However, backpackers collect static routes, transport, introductions, photos and other information only through the scenic area official websites and personal blogs prior to. At present, there is no data processing system and method been developed to conveniently provide dynamic and location-based tour guiding information for ordinary people.

Furthermore, mobile communication apparatuses (for example, tablet computers, smart phones, etc.) are increasingly popular. However, tourists holding mobile communication apparatuses can access only static tourism information through network. At present, there is no data processing system and method been developed to produce tour guiding information and to interact with mobile communication apparatuses.

### SUMMARY OF THE INVENTION

Accordingly, one scope of the invention is to provide a data processing system and method for generating a guiding information available for activities associated with predetermined routes or tours. The data processing system and method of the invention make it easy for non-professionals to involve in the production of guiding information of multimedia, especially for tour guiding information. The data processing system and method of the invention can produce guiding information of multimedia triggered by parameters of assigned positions. The data processing system and method of the invention can interact with mobile communication apparatuses.

According to a preferred embodiment of the invention, a data processing system for generating a guiding information includes an importing module, an editing module and a generating module. A producer imports a plurality of first parameters relative to a plurality of positions through the importing module. The producer edits a plurality of introduction information of the plurality of positions through the editing module. The generating module is respectively coupled to the importing module and the editing module. The generating module is for generating said guiding information in accordance with the plurality of first parameters relative to the plurality of positions and the plurality of introduction information of the plurality of positions.

In one embodiment, the editing module therein stores a plurality of scrip information which each includes a plurality of scene information. The producer assigns one from the plurality of scrip information through the editing module. The plurality of scene information of the assigned scrip information serve as the plurality of introduction information of the plurality of positions. Each scene information in the assigned scrip information corresponds to one of the positions.

In another embodiment, the producer imports a scrip information including a plurality of scene information through the editing module. The plurality of scene information of the scrip information serve as the plurality of introduction information of the plurality of positions. Each scene information in the scrip information corresponds to one of the positions.

Further, the data processing system of the invention also includes a user interaction module which is coupled to the generating module and capable of communicating with a mobile communication apparatus operated by a user. The user transmits a request information to the user interaction module through the mobile communication apparatus. The user interaction module accesses the guiding information in accordance with the request information. When the user via the mobile communication apparatus senses a plurality of second parameters relative to one of the plurality of positions and transmits the sensed second parameters to the user interaction module, the user interaction module compares the sensed second parameters to the first parameters relative to said one position, and if YES, the user interaction module transmits a portion of the guiding information corresponding to said one position to the mobile communication apparatus.

According to another preferred embodiment of the invention, a data processing method for generating a guiding information is firstly to import a plurality of first parameters relative to a plurality of positions. Next, the data processing method of the invention is to edit a plurality of introduction information of the plurality of positions. Finally, the data processing method of the invention is to generate the guiding information in accordance with the plurality of first parameters relative to the plurality of positions and the plurality of introduction information of the plurality of positions.

In one embodiment, the first parameters relative to each of the positions include a longitude, a latitude, an altitude, an orientation, a tilt angle, a relative position, an acceleration, a time, a date, an image characteristic, etc.

Distinguishable from the prior art, the data processing system and method of the invention provide unprecedented way by which users can interact with multimedia. Moreover, the data processing system and method of the invention make it easy for non-professionals to involve in the production of guiding information of multimedia.

The advantage and spirit of the invention may be understood by the following recitations together with the appended drawings.

### BRIEF DESCRIPTION OF THE APPENDED DRAWINGS

FIG. 1 is a schematic diagram showing the architecture of a data processing system according to a preferred embodiment of the invention.

FIG. 2 is a schematic diagram showing a map which covers a route assisting in illustrating the data processing system 1 of the invention.

FIG. 3 is a schematic diagram showing a map of a famous scenery which covers plurality of scenes assisting in illustrating the data processing system of the invention.

FIG. 4 schematically shows the display of a mobile communication apparatus operated a user.

FIG. 5 is a flow diagram illustrating a data processing method according to a preferred embodiment of the invention.

FIG. 6 is a further flow diagram illustrating the data processing method of the invention.

### DETAILED DESCRIPTION OF THE INVENTION

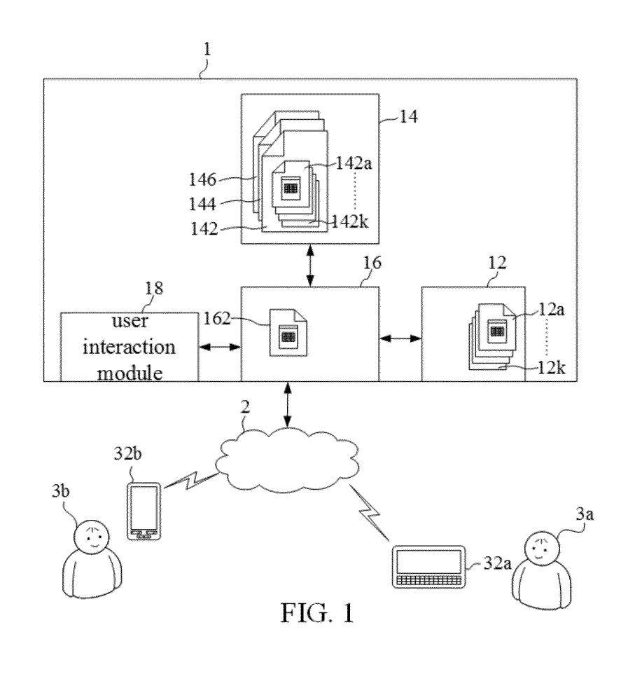

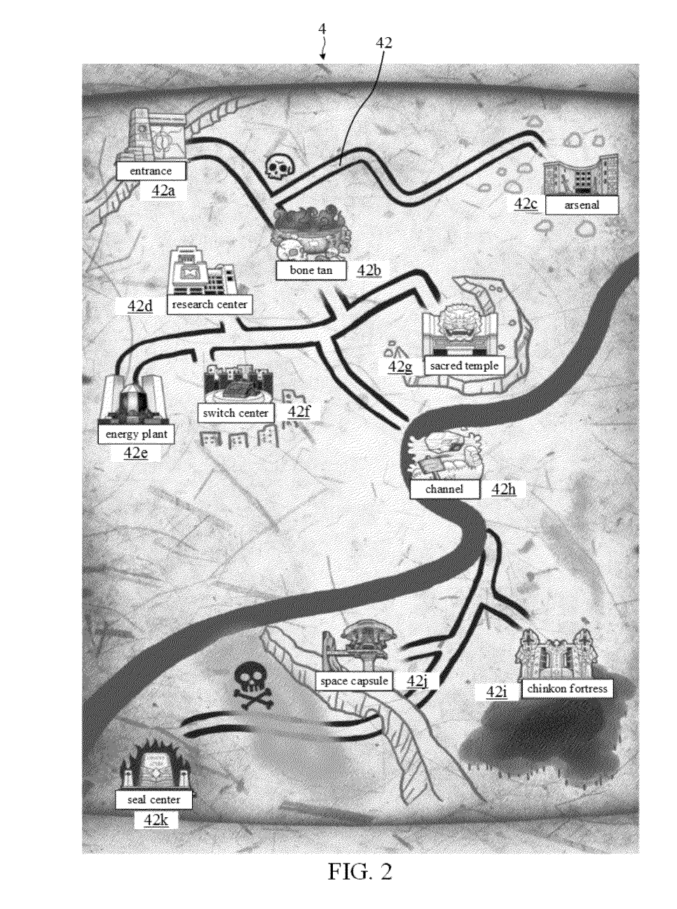

Referring to FIG. 1 and FIG. 2, FIG. 1 schematically shows an architecture of a data processing system 1 according to a preferred embodiment of the invention. FIG. 2 shows a map 4 which covers a route 42 assisting in illustrating the data processing system 1 of the invention. The data processing system 1 of the invention functions in generating a guiding information 162, for example, the guide information 162 of multimedia relative to the route 42.

As shown in FIG. 1, the data processing system 1 of the invention includes an importing module 12, an editing module 14 and a generating module 16. The data processing system 1 of the invention is linked to a network 2.

A data processing apparatus 32a is linked to the network 2. In practical application, the data processing apparatus 32a can be a desktop computer, a notebook computer, a tablet computer, a mobile phone, or other data processing apparatus. A producer 3a can operate the data processing apparatus 32a to communicate with and access data from the data processing system 1 of the invention through the network 2.

The producer 3a imports a plurality of first parameters relative to a plurality of positions (for example, the positions on the route 42 represented by notations 42a˜42k) through the importing module 12. In FIG. 1, notations 12a˜12k represent data sheets which each respectively stores the first parameters relative to one of the plurality of positions (42a˜42k).

In one embodiment, the first parameters relative to each of the plurality of positions (42a˜42k) can include a longitude, a latitude, an altitude, an orientation, a tilt angle, a relative position, an acceleration, a time, a date, at least one image characteristic associated with said one position (42a˜42k), etc. The first parameters can be acquired by the producer 3a via various sensors or devices, or imported from the data processing apparatus 32a after been edited. In practical application, the first parameters can be conveniently acquired by the producer 3a via a mobile communication apparatus and a sensor thereof, such as a global positioning system (GPS) module, an accelerator, an electronic gyroscope, etc. If the route 42 is in closed places (e.g., playgrounds, shopping malls, etc.), the first parameter can be relative positions acquired by use of current positioning technologies with RFID tag, Bluetooth , Wi-Fi and so on.

The producer 3a edits a plurality of introduction information (142a˜142k) of the plurality of positions (42a˜42k) through the editing module 14. The generating module 16 is respectively coupled to the importing module 12 and the editing module 14. The generating module 16 is for generating the guiding information 162 in accordance with the plurality of first parameters relative to the plurality of positions (42a˜42k) and the plurality of introduction information (142a˜142k) of the plurality of positions (42a˜42k). In practical application, the guiding information 162 includes an APP application capable of being executed on a mobile communication platform such as iOS, Android, Window, etc.

In one embodiment, the editing module 14 therein stores a plurality of scrip information (142, 144, 146) which each includes a plurality of scene information. The producer 3a assigns one from the plurality of scrip information (142, 144, 146) through the editing module 14. The plurality of scene information of the assigned scrip information (e.g., the scrip information 142) serve as the plurality of introduction information (142a˜142k) of the plurality of positions (42a˜42k). Each scene information (142a˜142k) in the assigned scrip information 142 corresponds to one of the positions (42a˜42k).

In another embodiment, the producer 3a imports a scrip information 142 including a plurality of scene information through the editing module 14. The plurality of scene information of the scrip information 142 serve as the plurality of introduction information (142a˜142k) of the plurality of positions (42a˜42k). Each scene information (142a˜142k) in the scrip information 142 corresponds to one of the positions (42a˜42k).

In one embodiment, each of the scene information (142a˜142k) can include text information, picture information, animation information, voice information, image information, game program, etc.

Further, also shown in FIG. 1, the data processing system 1 of the invention also includes a user interaction module 18 which is coupled to the generating module 16. A mobile communication apparatus 32b is linked to the network 2. A user 3b operates the mobile communication apparatus 32b to communicate with the data processing system 1 of the invention through the network 2 to access data. That is to say that the user interaction module 18 is capable of communicating with the mobile communication apparatus 32b.

The user 3b transmits a first request information to the user interaction module 18 through the mobile communication apparatus 32b. The user interaction module 18 accesses the guiding information 162 in accordance with the first request information. In practical application, the user interaction module 18 transmits an APP application, which can be executed on the platform of the mobile communication apparatus 32b, to the mobile communication apparatus 32b. Then, the user interaction module 18 executes the APP application.

When the user 3b via the mobile communication apparatus 32b senses a plurality of second parameters relative to one of the plurality of positions (42a˜42k) and transmits the sensed second parameters to the user interaction module 18, the user interaction module 18 compares the sensed second parameters to the first parameters relative to said one position (42a˜42k), and if YES, the user interaction module 18 transmits a portion of the guiding information 162 corresponding to said one position (42a˜42k) to the mobile communication apparatus 32b. Then, the mobile communication apparatus 32b executes the received portion of the guiding information 162. In practical application, the types of the second parameters are the same as those of the first parameters.

Referring to table 1, an example of the corresponding relationship between the scene information (142a˜142k) and the positions (42a˜42k) and the corresponding types of the first parameters is listed in table 1. The data listed in table 1 also relates to the example shown in FIG. 2. The example shown in table 1 and FIG. 2 obtains the guiding information 162 relative to the route 42 by use of the data processing system 1 of the invention. In the example, the scrip information 142 is the adventure type. Thus, the scrip information 142 includes the scene information 142a named as “entrance”, the scene information 142b named as “bone tan”, the scene information 142c named as “arsenal”, the scene information 142d named as “research center”, the scene information 142e named as “energy plant”, the scene information 142f named as “switch center”, the scene information 142g named as “sacred temple”, the scene information 142h named as “channel”, the scene information 142i named as “chinkon fortress”, the scene information 142j named as “space capsule”, and the scene information 142k named as “seal center”. The first parameters corresponding to each of the scene information (142a˜142k) is the parameters which trigger said one scene information (142a˜142k) in being executed.

TABLE 1

| | | Name of the scene |
|---|---|---|
| Position | Type of the first parameter | information |
| 42a | longitude, latitude | entrance (142a) |
| 42b | longitude, latitude | bone tan (142b) |
| 42c | image characteristic | arsenal (142c) |
| 42d | image characteristic | research center (142d) |
| 42e | longitude, latitude, acceleration | energy plant (142e) |
| 42f | orientation, tilt angle | switch center (142f) |
| 42g | longitude, latitude | sacred temple (142g) |
| 42h | longitude, latitude | channel (142h) |
| 42i | longitude, latitude, orientation | chinkon fortress (142i) |
| 42j | longitude, latitude | space capsule (142j) |
| 42k | longitude, latitude, acceleration | seal center (142k) |

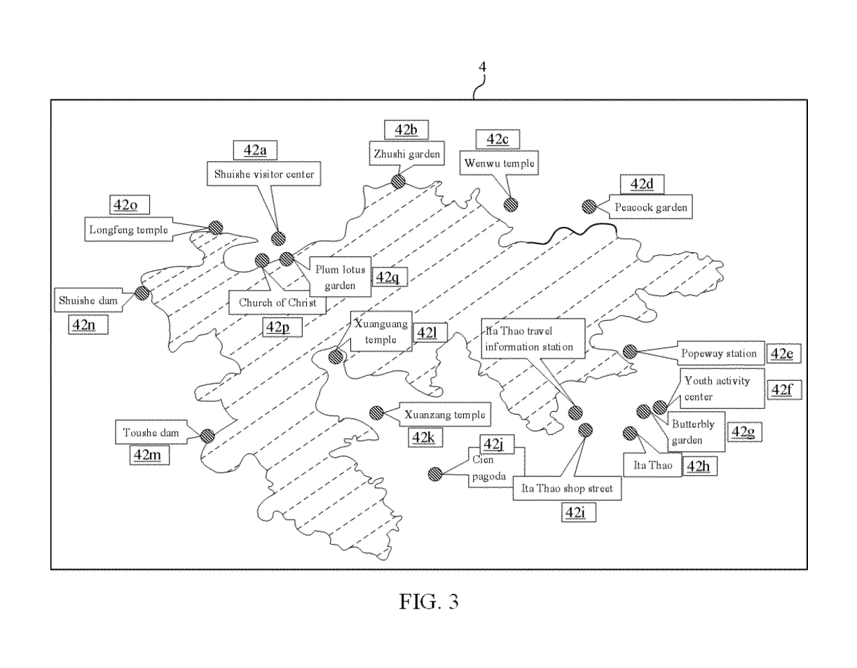

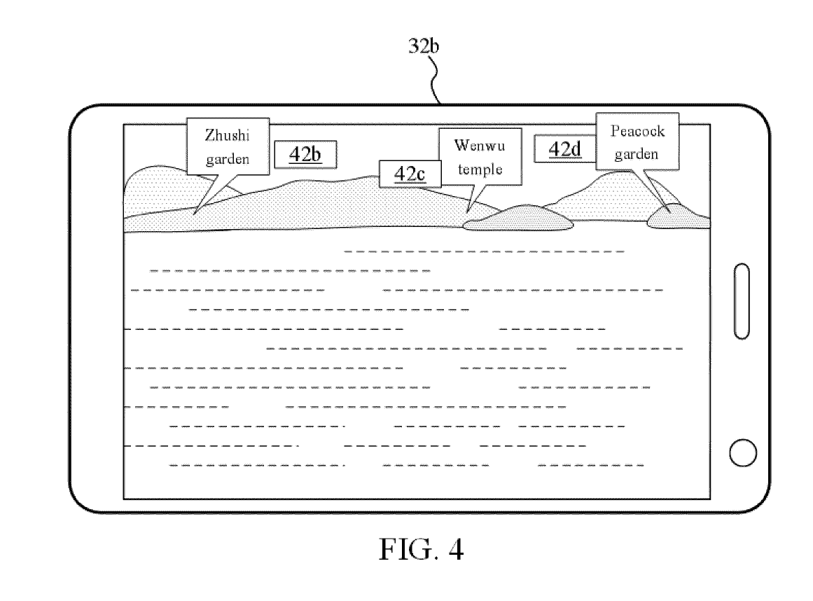

Referred to FIG. 3 and FIG. 4, FIG. 3 is a schematic map 4 of a famous scenery—Sun Moon Lake. FIG. 4 schematically shows the display of the mobile communication apparatus 32b operated the user 3b. The map 4 of FIG. 3 covers a plurality of scenes (42a˜42q) assisting in illustrating the data processing system 1 of the invention. The data processing system 1 of the invention generates a tour guiding information 162 relative to the scenes (42a˜42q).

As shown in FIG. 4, further, the user 3b transmits a second request information to the user interaction module 18 through the mobile communication apparatus 32b. The user interaction module 18 accesses the tour guiding information 162 in accordance with the second request information. Moreover, when the user 3b via the mobile communication apparatus 32b senses a plurality of third parameters relative to the position where the user 3b locates and transmits the sensed third parameters to the user interaction module 18, the user interaction module 18 generates a display information of labelling scene in accordance with the third parameters and the first parameters corresponding to the scenes (42a˜42q) and transmits the display information of labelling scene to the mobile communication apparatus 32b. The mobile communication apparatus 32b displays the display information of labelling scene. The example shown in FIG. 4 is that the user 3b locating at the scene 42l—Xuanguang temple holds the mobile communication apparatus 32b and watches forwards the north-east. At this time, the user interaction module 18 generates the display information of labelling scene in accordance with the third parameters and the first parameters corresponding to the scenes (42a˜42q), on the display of the mobile communication apparatus 32b, only the scene 42b—Zhushi garden, the scene 42c—Wenwu temple and the scene 42d—Peacock garden in FIG. 3 are labelled in the display information of labelling scene.

In one embodiment, the third parameters relative to each of the plurality of positions (42a˜42k) can include a longitude, a latitude, an altitude, an orientation, a tilt angle, a relative position, etc.

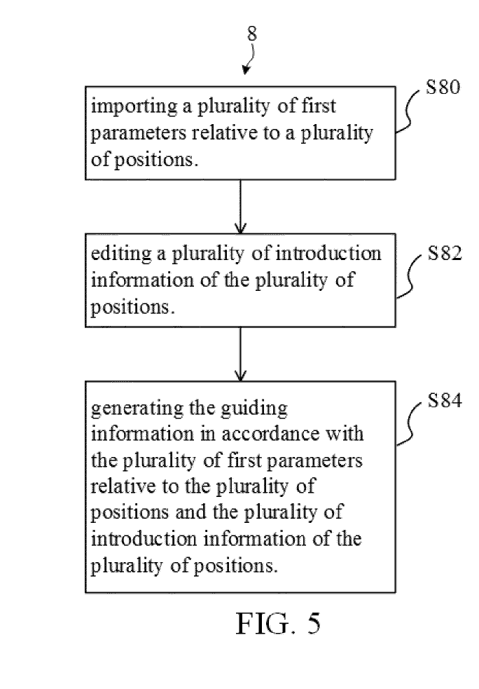

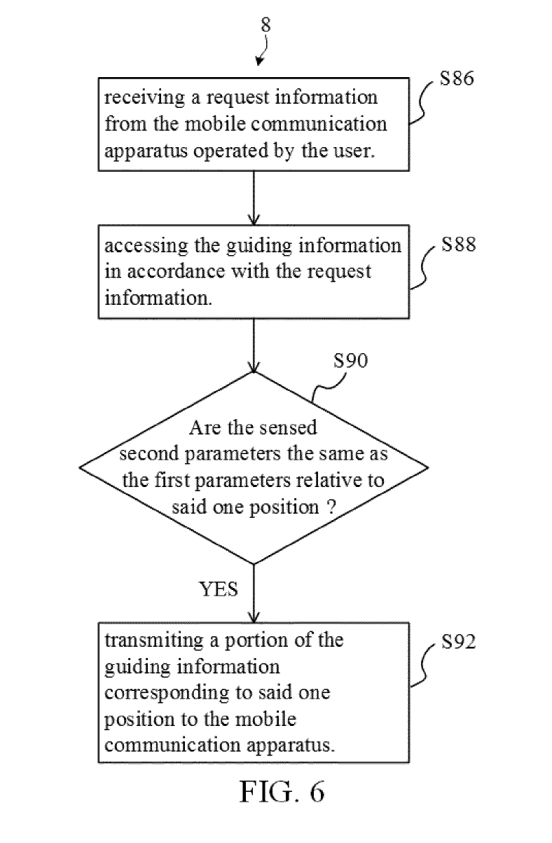

Referred to FIG. 5 and FIG. 6, together FIG. 2 and FIG. 3, these drawings are flowchart diagrams illustrating a data processing method 8 according to a preferred embodiment of the invention. The data processing method 8 of the invention functions in generating a guiding information 162, for example, the guide information 162 of multimedia relative to the route 42. The data processing method 8 of the invention cab be practiced, but not limited to, by the data processing system 1 of the invention shown in FIG. 1.

As shown in FIG. 5, the data processing method 8 of the invention, firstly, performs step S80 to import a plurality of first parameters relative to a plurality of positions (42a˜42k).

Next, the data processing method 8 of the invention performs step S82 to edit a plurality of introduction information (142a˜142k) of the plurality of positions (42a˜42k).

Finally, the data processing method 8 of the invention performs step S84 to generate the guiding information 162 in accordance with the plurality of first parameters relative to the plurality of positions (42a˜42k) and the plurality of introduction information (142a˜142k) of the plurality of positions (42a˜42k).

In one embodiment, a plurality of scrip information (142, 144, 146), which each includes a plurality of scene information, are previously stored. Step S82 is performed by assigning one from the plurality of scrip information (142, 144, 146). The plurality of scene information of the assigned scrip information (e.g., the scrip information 142) serve as the plurality of introduction information (142a˜142k) of the plurality of positions (42a˜42k). Each scene information (142a˜142k) in the assigned scrip information 142 corresponds to one of the positions (42a˜42k).

In another embodiment, step S82 is performed by importing a scrip information 142 including a plurality of scene information. The plurality of scene information of the scrip information 142 serve as the plurality of introduction information (142a˜142k) of the plurality of positions (42a˜42k). Each scene information (142a˜142k) in the scrip information 142 corresponds to one of the positions (42a˜42k).

In one embodiment, the first parameters relative to each of the positions include a longitude, a latitude, an altitude, an orientation, a tilt angle, a relative position, an acceleration, a time, a date, an image characteristic, etc.

In one embodiment, each of the scene information (142a˜142k) can include text information, picture information, animation information, voice information, image information, game program, etc.

As shown in FIG. 6, further, the data processing method 8 of the invention performs step S86 to receive a request information from the mobile communication apparatus 32b operated by the user 3b. The mobile communication apparatus 32b is linked to the network 2.

Afterward, the data processing method 8 of the invention performs step S88 to access the guiding information 162 in accordance with the request information.

Next, the data processing method 8 of the invention performs step S90 to receive a plurality of second parameters relative to one of the plurality of positions (42a˜42k) sensed by the mobile communication apparatus 32b.

Finally, the data processing method 8 of the invention performs step S92 to compare the sensed second parameters to the first parameters relative to said one position (42a˜42k), and if YES, performs step S92 to transmit a portion of the guiding information 162 corresponding to said one position (42a˜42k) to the mobile communication apparatus 32b. Then, the mobile communication apparatus 32b executes the received portion of the guiding information 162. In practical application, the types of the second parameters are the same as those of the first parameters.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data processing system for generating a guiding information, comprising:
an importing module through which a producer imports a plurality of first parameters relative to a plurality of positions;
an editing module through which the producer edits a plurality of introduction information of the plurality of positions; and
a generating module, respectively coupled to the importing module and the editing module, for generating said guiding information in accordance with the plurality of first parameters relative to the plurality of positions and the plurality of introduction information of the plurality of positions.

2. The data processing system of claim 1, wherein the editing module therein stores a plurality of scrip information which each comprises a plurality of scene information, the producer assigns one from the plurality of scrip information through the editing module, the plurality of scene information of the assigned scrip information serve as the plurality of introduction information of the plurality of positions, each scene information in the assigned scrip information corresponds to one of the positions.

3. The data processing system of claim 1, wherein the producer imports a scrip information comprising a plurality of scene information through the editing module, the plurality of scene information of the scrip information serve as the plurality of introduction information of the plurality of positions, each scene information in the scrip information corresponds to one of the positions.

4. The data processing system of claim 1, further comprising:
a user interaction module, being coupled to the generating module and capable of communicating with a mobile communication apparatus operated by a user, wherein the user transmits a request information to the user interaction module through the mobile communication apparatus, the user interaction module accesses the guiding information in accordance with the request information, when the user via the mobile communication apparatus senses a plurality of second parameters relative to one of the plurality of positions and transmits the sensed second parameters to the user interaction module, the user interaction module compares the sensed second parameters to the first parameters relative to said one position, and if YES, the user interaction module transmits a portion of the guiding information corresponding to said one position to the mobile communication apparatus.

5. The data processing system of claim 1, wherein the first parameters relative to each of the positions comprise at least one selected from the group consisting of a longitude, a latitude, an altitude, an orientation, a tilt angle, a relative position, an acceleration, a time, a date, and an image characteristic.

6. A data processing method for generating a guiding information, comprising the steps of:
importing a plurality of first parameters relative to a plurality of positions;
editing a plurality of introduction information of the plurality of positions; and
generating said guiding information in accordance with the plurality of first parameters relative to the plurality of positions and the plurality of introduction information of the plurality of positions.

7. The data processing method of claim 6, wherein a plurality of scrip information are previously stored, each of the plurality of scrip information comprises a plurality of scene information, the step of editing a plurality of introduction information of the plurality of positions is performed by assigning one from the plurality of scrip information, the plurality of scene information of the assigned scrip information serve as the plurality of introduction information of the plurality of positions, each scene information in the assigned scrip information corresponds to one of the positions.

8. The data processing method of claim 6, wherein the step of editing a plurality of introduction information of the plurality of positions is performed by importing a scrip information comprising a plurality of scene information, the plurality of scene information of the scrip information serve as the plurality of introduction information of the plurality of positions, each scene information in the scrip information corresponds to one of the positions.

9. The data processing method of claim 6, further comprising the steps of:
receiving a request information from a mobile communication apparatus operated by a user;
accessing the guiding information in accordance with the request information;
receiving a plurality of second parameters relative to one of the plurality of positions sensed by the mobile communication apparatus;
comparing the sensed second parameters to the first parameters relative to said one position, and if YES, transmitting a portion of the guiding information corresponding to said one position to the mobile communication apparatus.

10. The data processing method of claim 6, wherein the first parameters relative to each of the positions comprise at least one selected from the group consisting of a longitude, a latitude, an altitude, an orientation, a tilt angle, a relative position, an acceleration, a time, a date, and an image characteristic.
